(19) United States
(12) Patent Application Publication
(10) Pub. No.: US 2009/0052205 A1
(43) Pub. Date: Feb. 26, 2009

(54) LIGHT SOURCE MODULE OF SCANNING DEVICE

(76) Inventors: Ching-Chung CHEN, Taipei Hsien (TW); Yen-Chun Chou, Taipei City (TW)

Correspondence Address: SINORICA, LLC, 528 FALLSGROVE DRIVE, ROCKVILLE, MD, 20850, US

(21) Appl. No.: 11/964,356

(22) Filed: Dec. 26, 2007

(30) Foreign Application Priority Data
Aug. 23, 2007 (TW) 096131285

(51) Int. Cl. F21V 7/04

(52) U.S. Cl. 362/612; 362/615

(57) ABSTRACT

A light source module of scanning device includes a light guide rod and a light emitting diode. The light guide rod has a top surface, a bottom surface and two end portions. The top surface and the bottom surface are disposed opposite to each other. The light emitting diode is disposed adjacent to one of the end portions.

### CROSS REFERENCE TO RELATED APPLICATIONS

This Non-provisional application claims priority under 35 U.S.C. §119(a) on Patent Application No(s). 096131285 filed in Taiwan, Republic of China on Aug. 23, 2007, the entire contents of which are hereby incorporated by reference.

### BACKGROUND OF THE INVENTION

1. Field of Invention

The invention relates to a light source module and, in particular, to a light source module of a scanning device.

2. Related Art

Data image inputs of modern scanners, fax machines, copy machines, or multi-function peripherals require the use of light sources during the scanning process. Therefore, the light-emitting efficiency, stability, and starting time of the light source are closely related to the overall quality and performance of the scanning device.

As shown in FIG. 1, a conventional scanning device 1, which is a scanner, includes an image sensor 11, a light source 12 and a transparent supporting plate 13. The image sensor 11 can be a charge-coupled device (CCD). The transparent supporting plate 13 is a glass supporting plate. The light source 12 can be a cold-cathode fluorescent lamp (CCFL), a linear light source, and disposed between the transparent supporting plate 13 and the image sensor 11. When the scanning device 1 scans a document 14 is disposed on the transparent supporting plate 13, the light emitted by the light source 12 scans through the surface of the document 14 for the image sensor 11 to receive the light reflected by the document 14. This completes the scanning process of the scanning device 1.

However, using the CCFL as the light source 12, the starting time and light-emitting efficiency of the conventional scanning device 1 are worse than the scanning device using the light-emitting diode (LED) as the light source.

Therefore, it is an important subject to provide a light source module of a scanning device that has a shorter starting time and enhanced light-emitting efficiency to increase the overall scanning speed and quality of the scanning device.

### SUMMARY OF THE INVENTION

In view of the foregoing, the invention is to provide a light source module of a scanning device that has a shorter starting time and a longer lifetime so as to increase the overall scanning speed and quality of the scanning device.

To achieve the above, the invention discloses a light source module of a scanning device. The light source module includes a light guide rod and a light-emitting diode (LED). The light guide rod has a top surface, a bottom surface and two end portions. The top surface and the bottom surface are disposed opposite to each other. The LED is disposed adjacent to one of the end portions.

To achieve the above, the invention also discloses a light source module of a scanning device. The light source module includes a light guide rod and an LED. The light guide rod has a top surface and a bottom surface disposed opposite to each other. The LED is disposed adjacent to the bottom surface.

As mentioned above, the light source module of a scanning device according to the invention utilizes an LED disposed on the end portion or bottom surface of the light guide rod. The light emitted by the LED goes out uniformly via the light guide rod. In comparison with the prior art, the light source module of the invention does not only enhance the light-emitting efficiency but also shortens the starting time thereof Moreover, the life time of the light source module can be extended. Therefore, the overall scanning speed and quality of the scanning device are improved.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic view of a conventional scanning device and a light source thereof;

FIG. 2 is a schematic view of a light source module of a scanning device according to a first embodiment of the invention;

FIGS. 3A and 3B show variations of the top surface of the light source module according to the first embodiment;

FIG. 3C is a cross-sectional view of the light source module of the scanning device according to the first embodiment;

FIG. 4 is a schematic view of a light source module of a scanning device according to a second embodiment of the invention;

FIG. 5 is a schematic view of a light source module of a scanning device according to a third embodiment of the invention; and

FIG. 6 is a schematic view of a light source module of a scanning device according to a fourth embodiment of the invention.

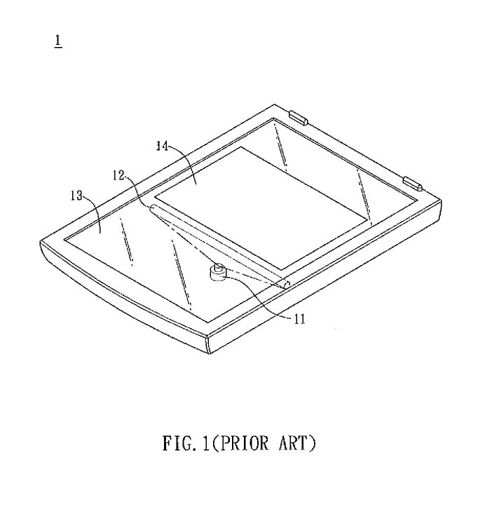

### DETAILED DESCRIPTION OF THE INVENTION

The present invention will be apparent from the following detailed description, which proceeds with reference to the accompanying drawings, wherein the same references relate to the same elements.

### First Embodiment

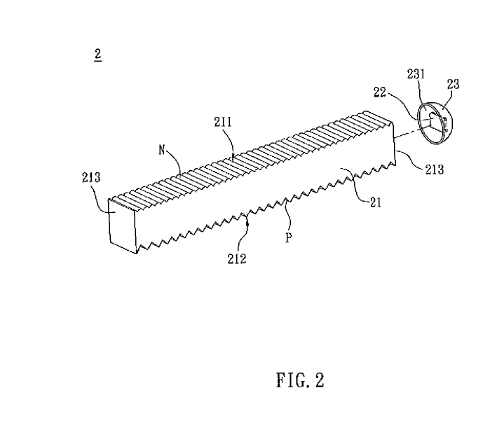

As shown in FIG. 2, a light source module 2 of a scanning device according to a first embodiment of the invention includes a light guide rod 21 and an LED 22. The light guide rod 21 has a top surface 211, a bottom surface 212 and two end portions 213. The light guide rod 21 can be a rectangular or wedge light guide rod with a flat bottom surface or a rectangular light guide rod with a curved bottom surface. In this embodiment, the light guide rod 21 is a rectangular light guide rod. The top surface 211 and the bottom surface 212 are disposed opposite to each other. The top surface 211 is a light-emitting surface, and the bottom surface 212 is a reflective surface. In this embodiment, the top surface 211 has several lenticular lenses N disposed in parallel. The bottom surface 212 has several prisms, at least one Fresnel lens or several mesh points. This embodiment preferably has several prisms P disposed in parallel on the bottom surface 212.

The LED 22 is an LED device or a die disposed adjacent to one of the end portions 213. In addition, the light source module 2 further includes a reflective element 23 surrounding the LED 22. In particular, the reflective element 23 is preferably a reflective mask, which has a reflective layer 231 on the side facing the LED 22.

The propagation of light from the light source module 2 is as follows. The light is emitted by the LED 22 and reflected by the reflective layer 231. The light then enters the light guide rod from one end portion 213 thereof Afterwards, the prisms P on the bottom surface 212 reflect the light to the top surface 211, where the light is emitted. The top surface 211 can have lenticular lenses N for evenly distributing emitted light and enhancing the central energy thereof. Therefore, the light guide rod 21 mimics a linear light source for the convenience of document scanning.

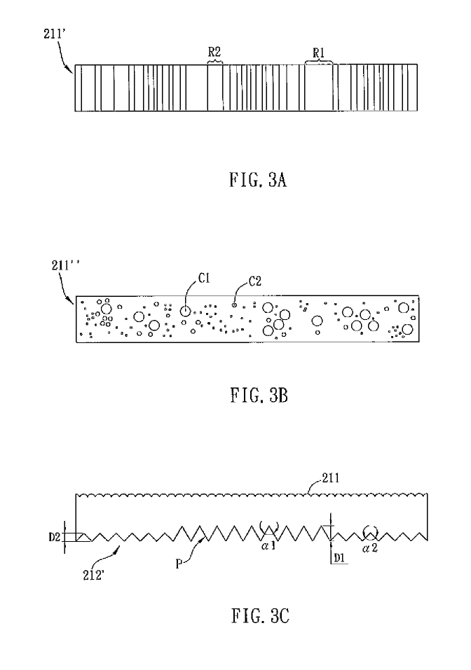

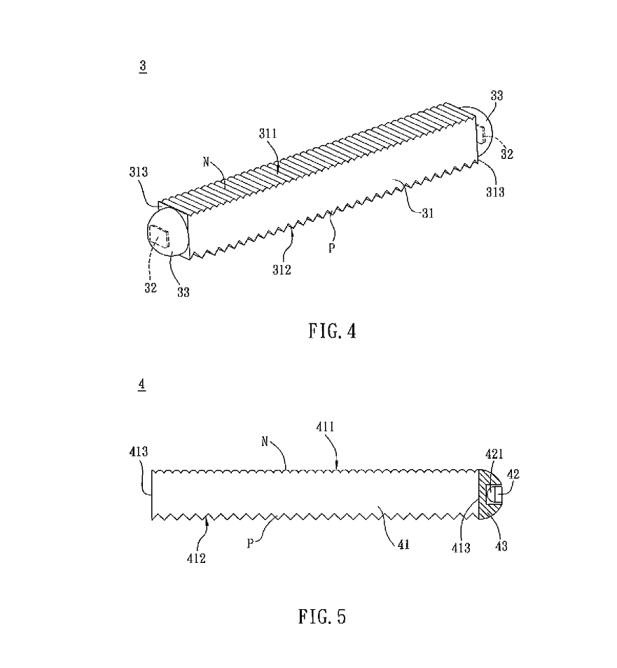

FIGS. 3A to 3C show various aspects of the top surface 211 and bottom surface 212 of the light guide rod 21 according to the first embodiment. FIG. 3A is a top view of the top surface 211′. As shown in FIG. 3A, the top surface 211′ consists of lenticular lenses N of different curvature radii R1, R2 and pitches to enhance light-emitting efficiency and avoid fringes due to regular scattering. FIG. 3B is a top view of the top surface 211″. As shown in FIG. 3B, the top surface 211″ consists of convex and/or concave portions C1, C2 of different sizes so that the light distribution is more uniform. FIG. 3C is a cross-sectional view of the bottom surface 212′. As shown in FIG. 3C, the vertex angles α1, α2 of the prisms P on the bottom surface 212′ can be different, and the groove depths D1, D2 of the prisms P can be different as well. For example, the vertex angle α1 in the central portion is smaller than the vertex angle α2 on both sides, and the groove depth D1 in the central portion is greater than the groove depth D2 on both sides.

### Second Embodiment

As shown in FIG. 4, a light source module 3 of a scanning device according to a second embodiment of the invention includes a light guide rod 31, two LED's 32 and two reflective elements 33. The basic structure and functions of the light guide rod 31 are the same as those of the light guide rod 21 in the first embodiment, so the descriptions thereof will be omitted. The difference between this embodiment and the first embodiment is in that the light source module 3 has two LED's 32 and two reflective elements 33 disposed respectively on the two end portions 313 of the light guide rod 31 for enhancing the brightness of the light source module 3

### Third Embodiment

As shown in FIG. 5, a light source module 4 of a scanning device according to a third embodiment of the invention includes a light guide rod 41 and a LED 42. The structures and functions of the light guide rod 41 and the LED 42 are the same as those of the light guide rod 21 and the LED 22 in the first embodiment, so the detailed descriptions thereof will be omitted. The difference between this embodiment and the first embodiment is that, in addition to a molding 421, the LED 42 of the light source module 4 has a light guide lens 43 covering thereon. The light guide lens 43 can modify the optical shape of the light emitted by the LED 42 and enhance the light usage thereof.

To be noted, the LED 42 can be disposed concurrently on the two end portions 413 of the light guide rod 41.

### Fourth Embodiment

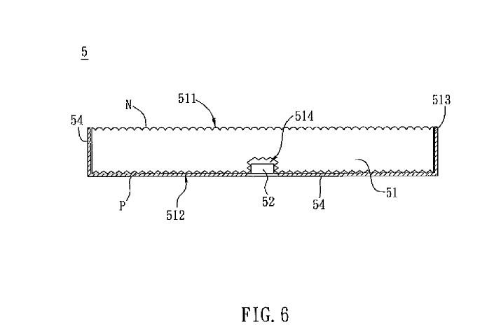

Referring to FIG. 6, a light source module 5 of a scanning device according to a fourth embodiment of the invention includes a light guide rod 51 and an LED 52. The light guide rod 51 can be rectangular, arc-shaped or wedge-shaped. In this embodiment, the light guide rod 51 is rectangular and has a top surface 511 and a bottom surface 512 opposite to each other. The difference between the light guide rod 51 in this embodiment and the light guide rod 21 in the first embodiment is that the bottom surface 512 of the light guide rod 51 has a concave portion 514 where the LED 52 is embedded. In addition, the two end portions 513 of the light guide rod 51 and/or the bottom surface 512 can be formed with a reflective board 54 to enhance the light usage.

After the light is emitted from the LED 52, it enters the light guide rod 51 via the concave portion 514. The prisms P and the reflective board 54 on the bottom surface 512 reflect the light to the top surface 511. Since the top surface 511 has lenticular lenses N, the outgoing light has a uniform distribution and its central energy can be enhanced.

In summary, the light source module of a scanning device according to the invention utilizes an LED disposed on the end portion or bottom surface of the light guide rod. The light emitted by the LED goes out uniformly via the light guide rod. In comparison with the prior art, the light source module of the invention does not only enhance the light-emitting efficiency but also shortens the starting time thereof. Moreover, the life time of the light source module can be extended. Therefore, the overall scanning speed and quality of the scanning device are improved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light source module of a scanning device, comprising:
a light guide rod having a top surface, a bottom surface and two end portions, wherein the top surface and the bottom surface are disposed opposite to each other; and
a light emitting diode (LED) disposed adjacent to one of the end portions.

2. The light source module of claim 1 further comprising:
a reflective element disposed around the LED.

3. The light source module of claim 1, wherein the top surface is a light-emitting surface, and the bottom surface is a reflective surface.

4. The light source module of claim 3, wherein the light-emitting surface has a plurality of lenticular lenses, a plurality of convex portions and/or a plurality of concave portions.

5. The light source module of claim 4, wherein the curvature radii and pitches of the lenticular lenses are different.

6. The light source module of claim 1, wherein the bottom surface has a plurality of prisms, at least one Fresnel lens or a plurality of mesh points.

7. The light source module of claim 6, wherein the prisms have at least two different vertex angles.

8. The light source module of claim 6, wherein the prisms have at least two different groove depths.

9. The light source module of claim 1 further comprising:
a light guide lens covering the LED.

10. A light source module of a scanning device, comprising:
a light guide rod having a top surface and a bottom surface disposed opposite to each other; and
an LED disposed adjacent to the bottom surface.

11. The light source module of claim 10, wherein the bottom surface has a concave portion, and the LED is embedded in the concave portion.

12. The light source module of claim 10 further comprising:
a reflective element disposed around the LED.

13. The light source module of claim 10, wherein the top surface is a light-emitting surface, and the bottom surface is a reflective surface.

14. The light source module of claim 13, wherein the light-emitting surface has a plurality of lenticular lenses, a plurality of convex portions and/or a plurality of concave portions.

15. The light source module of claim 14, wherein the curvature radii and pitches of the lenticular lenses are different.

16. The light source module of claim 10, wherein the bottom surface has a plurality of prisms, at least one Fresnel lens or a plurality of mesh points.

17. The light source module of claim 16, wherein the prisms have at least two different vertex angles.

18. The light source module of claim 16, wherein the prisms have at least two different groove depths.

19. The light source module of claim 11 further comprising:
a light guide lens covering the LED.
